(19) United States
(12) Patent Application Publication
(10) Pub. No.: US 2024/0051591 A1
(43) Pub. Date: Feb. 15, 2024

(54) SHOPPING CART

(71) Applicant: Toshiba Tec Kabushiki Kaisha, Tokyo (JP)

(72) Inventors: Katsuaki SAKURADA, Yokohama Kanagawa (JP); Masahiro YASUNO, Yokohama Kanagawa (JP); Katsuya TAKEDA, Yokohama Kanagawa (JP); Hachirou SAWADA, Yokohama Kanagawa (JP); Reiji SUGIKAMI, Yokohama Kanagawa (JP); Tomonori SUGIYAMA, Yokohama Kanagawa (JP); Hiroki TAKEDA, Saitama Saitama (JP)

(21) Appl. No.: 18/447,250

(22) Filed: Aug. 9, 2023

(30) Foreign Application Priority Data
Aug. 10, 2022 (JP) 2022-127822

(51) Int. Cl. B62B 3/14; H02J 7/00

(52) U.S. Cl. CPC B62B 3/1424; H02J 7/0047; H02J 7/0063; H02J 7/0045

(57) ABSTRACT

Provided is a shopping cart capable of simplifying equipment of a storage area of the shopping cart. A shopping cart allowed to be nested in a front-rear direction, includes: a cart body; a battery configured to supply power to an electronic device attached to the cart body and displayed commodity information read by a reading device; power receiving units and provided on a front side of the cart body and configured to be electrically connectable to an external power supply device; and power transmitting units and provided on a rear surface side of the power receiving units and configured to supply power to a power receiving units and of another shopping cart nested in the shopping cart.

### CROSS-REFERENCE TO RELATED APPLICATION

This application is based upon and claims the benefit of priority from Japanese Patent Application No. 2022-127822, filed Aug. 10, 2022, the entire contents of which are incorporated herein by reference.

### FIELD

Embodiments relates to a shopping cart, for example, a shopping cart mainly used in a store such as a supermarket or a shopping mall.

### BACKGROUND

Conventionally, in a store such as a supermarket or a shopping mall, payment is processed by a store clerk or a customer at a cash register provided in the store. Thus, for example, during busy hours, etc., customers waiting for payments are concentrated at the cash register, which not only makes the customers wait for a long time, but also places a heavy workload on the clerk processing the payments.

Therefore, a system has been proposed in which payment processing can be performed without going to the cash register by being equipped with electronic devices such as a reading device capable of reading commodity information and a display device capable of displaying payment information, etc. in a shopping cart, and a battery that supplies power to these electronic devices, and reading commodity information on the spot when a customer selects a commodity.

In the shopping cart used in this type of system, power is supplied from the battery to the electronic devices, and the battery needs to be charged. For example, while each shopping cart is provided with a power receiving device, a cart storage area in which a plurality of shopping carts is stored is provided with a plurality of power transmitting devices, and when shopping carts are stored in the cart storage area, the power receiving device of each shopping cart faces a power transmitting device in the cart storage area, so that the battery is supplied with power from the power transmitting device via the power receiving device.

However, in the shopping cart described above, each shopping cart is supplied with power from an individual power transmitting device. Thus, it is necessary to install a plurality of power transmitting devices in parallel on a side of the cart storage area, and there is a problem in that equipment of the cart storage area cannot be simplified.

The embodiments has been made by paying attention to such a problem, and an object of the embodiments is to provide a shopping cart capable of simplifying equipment of a storage area of the shopping cart.

### BRIEF DESCRIPTION OF THE DRAWINGS

FIGS. 1A and 1B are perspective views illustrating a shopping cart according to an embodiment.

FIG. 2 is a right side view illustrating the shopping cart.

FIG. 3 is a perspective view illustrating a state in which an opening/closing portion of a cover is opened.

FIG. 4A is a front view illustrating a lower part of a cart body, and FIG. 4B is a rear view illustrating the lower part of the cart body.

FIG. 5 is a partially broken plan view illustrating an external power supply device and a front portion of the lower body of the cart.

FIG. 6 is a right side view illustrating a state in which a plurality of shopping carts is stored in a cart storage area.

FIG. 7 is a cross-sectional view taken along the line A-A of FIG. 6.

FIG. 8A is a schematic view illustrating a state in which a power transmitting portion of the external power supply device and a power receiving portion of a foremost cart are not in contact, FIG. 8B is a schematic view illustrating a state in which the power transmitting portion of the external power supply device and the power receiving portion of the foremost cart are in contact, and FIG. 8C is a schematic view illustrating a state in which the power transmitting portion of the external power supply device, the power receiving portion of the foremost cart, and a power transmitting portion and a power receiving portion of a following cart are in contact.

FIG. 9 is a diagram illustrating a modified example of the embodiment.

### DETAILED DESCRIPTION

Modes for carrying out a shopping cart will be described below on the basis of embodiments.

### Embodiments

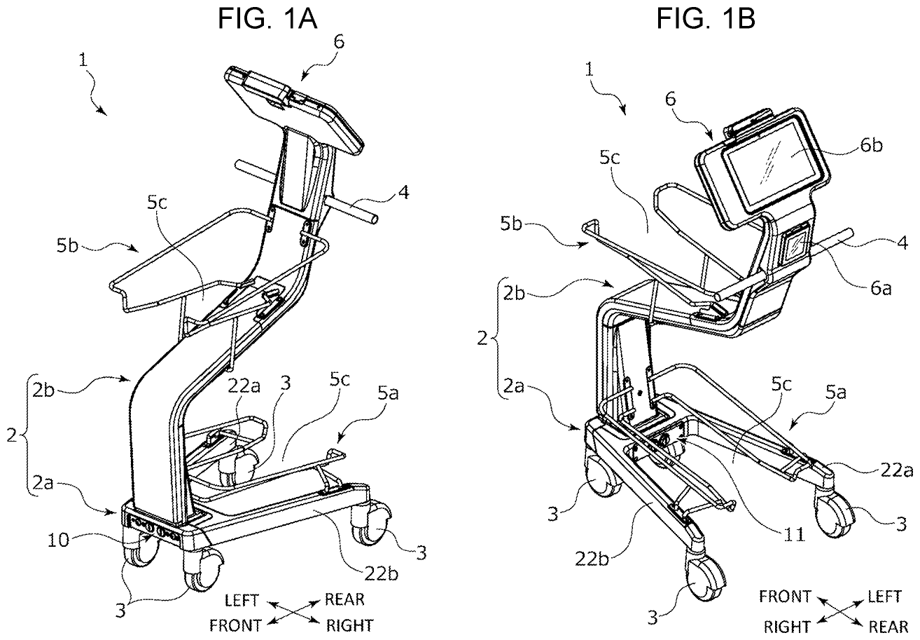

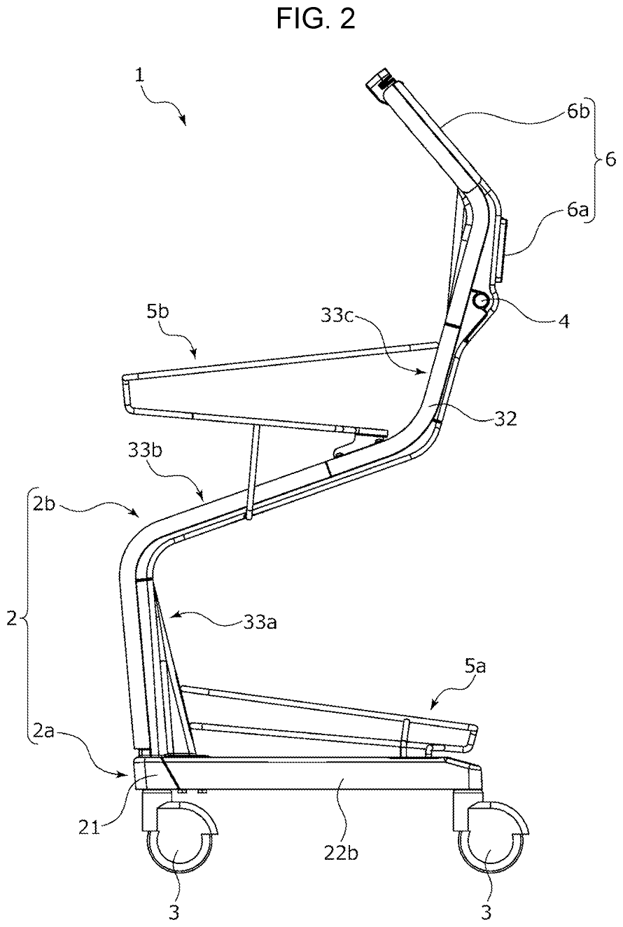

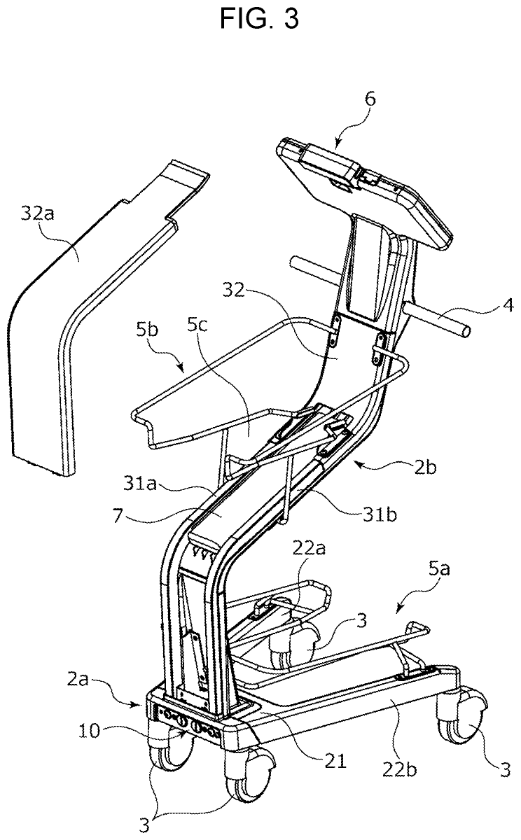

A shopping cart according to an embodiment will be described below with reference to FIGS. 1 to 8.

Note that, in the following description, a diagonally lower left of FIG. 1A is set as a front of the shopping cart, and front, rear, right, and left directions (see the arrows of FIG. 1) when viewing the shopping cart from the front are used as the reference.

As illustrated in FIGS. 1 to 5, for example, the shopping cart 1 (hereinafter abbreviated as a cart) is a cart used by customers to a supermarket, a shopping mall, etc. The cart 1 mainly includes a cart body 2, a plurality of (for example, four) casters 3 provided on a lower part of the cart body 2, a handle 4 operated by a user, two upper and lower placing portions 5a and 5b on which baskets (not illustrated) capable of holding commodities can be placed, an electronic device 6 used for payment processing of commodities selected by the user, a battery 7 capable of supplying power to the electronic device 6, a power receiving portion 10 for receiving power, and a power transmitting portion 11 for transmitting power, and can be nested in a front-rear direction as described later.

The cart body 2 mainly includes a lower body part 2a having a substantially bifurcated shape in a plan view disposed along a floor surface, and a plate-shaped upper body part 2b erected at a front of the lower body part 2a.

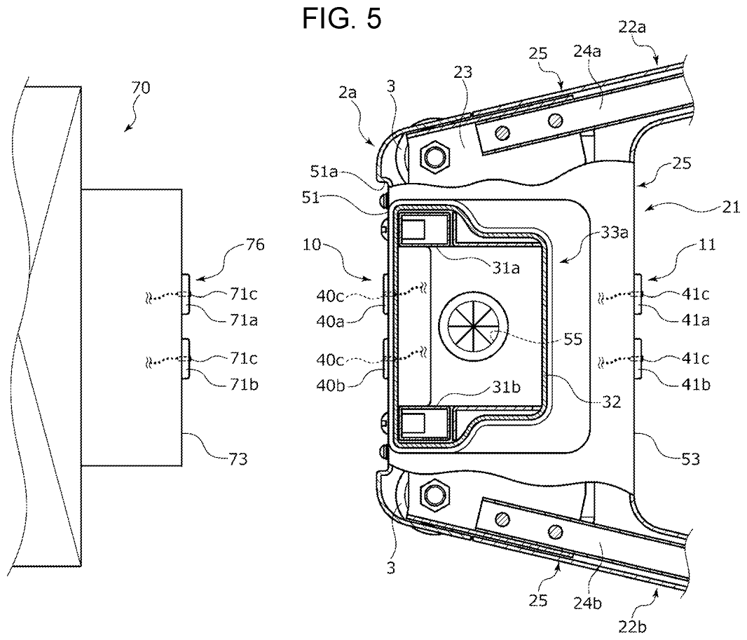

As illustrated in FIG. 5, the lower body part 2a has a base member 23 made of a metal plate, frame members 24a and 24b made of metal square tubes extending rearward from right and left sides of the base member 23, and a cover member 25 made of synthetic resin provided to cover the outside portions of the base member 23 and the frame members 24a and 24b, and includes a base 21 having a substantially trapezoidal shape in a plan view, and side frames 22a and 22b (as an example of cart guide frames) extending rearward from right and left sides of the base 21. The casters 3 are attached to the right and left sides of the base member 23 and lower parts of rear ends of the frame members 24a and 24b, and can move on the floor surface.

As illustrated in FIGS. 1 to 5, the power receiving portion 10 is provided on a front surface side of the base 21, and the power transmitting portion 11 is provided on a rear surface side thereof. Note that details of the power receiving portion 10 and the power transmitting portion 11 will be described below. The side frames 22a and 22b are spaced apart from each other to the right and left, and are arranged in a substantially V-shape in a plan view such that a distance therebetween gradually increases toward the rear side.

The upper body part 2b is configured in a plate shape having two frame members 31a and 31b (as an example of support frames) erected and separated from each other on right and left sides of an upper surface of the base member 23, a cylindrical cover member 32 provided to cover the outside portions of the frame members 31a and 31b, and has a first frame 33a extending forward and upward from an upper surface of the base 21, a second frame 33b extending rearward and upward from an upper end of the first frame 33a, and a third frame 33c extending rearward and upward from an upper end of the second frame 33b.

The right and left frame members 31a and 31b are made of metal square tubes, and are coupled at a plurality of upper and lower positions by coupling pipes (not illustrated) directed in a right-left direction. In addition, the cover member 32 is made of a synthetic resin material, a part thereof corresponding to the first frame 33a and the second frame 33b in a front surface portion serves as a removable opening/closing portion 32a, and the insides of the first frame 33a and the second frame 33b are opened by removing the opening/closing portion 32a.

Further, the battery 7 is stored in a space formed between the right and left frame members 31a and 31b in the second frame 33b. In this way, the battery 7 is compactly stored in the space formed between the right and left frame members 31a and 31b in the upper body part 2b included in the cart body 2, and is protected by the right and left frame members 31a and 31b having high strength. Further, by opening the opening/closing portion 32a, replacement and maintenance work of the battery 7 can be easily performed.

Further, the placing portion 5a arranged on the rear side of the first frame 33a and the placing portion 5b arranged on the front side of the third frame 33c are each formed into a box shape having a top opened by bending a linear member, and are attached to the frame members 31a and 31b using screw members. Specifically, the placing portion 5a is arranged behind the first frame 33a and below the second frame 33b, and the placing portion 5b is arranged in front of the first frame 33a and above the second frame 33b.

Further, a receiving portion 5c capable of receiving the upper body part 2b of another cart 1 extends in the front-rear direction at a central position of each of the placing portions 5a and 5b in the right-left direction. Note that the receiving portion 5c of the upper placing portion 5b is formed with a lateral width dimension that allows the opening/closing portion 32a to be inserted thereto, and thus does not in contact therewith when the opening/closing portion 32a is opened or closed.

The placing portion 5a is provided to be inclined downward toward the rear, the second frame 33b is provided to be inclined upward toward the rear, and a vertical distance between the second frame 33b and the lower body part 2a widens toward the rear, so that a customer easily puts a commodity from the rear of the cart 1 into a basket (not illustrated) placed on the placing portion 5a.

In the present embodiment, for example, a reading device 6a such as a reader for reading information of a commodity selected by the user of the cart 1 and an information terminal 6b that displays commodity information read by the reading device 6a and enables various operations are provided as the electronic device 6. However, other devices other than the above-mentioned devices used for payment processing of the commodity selected by the customer may be provided.

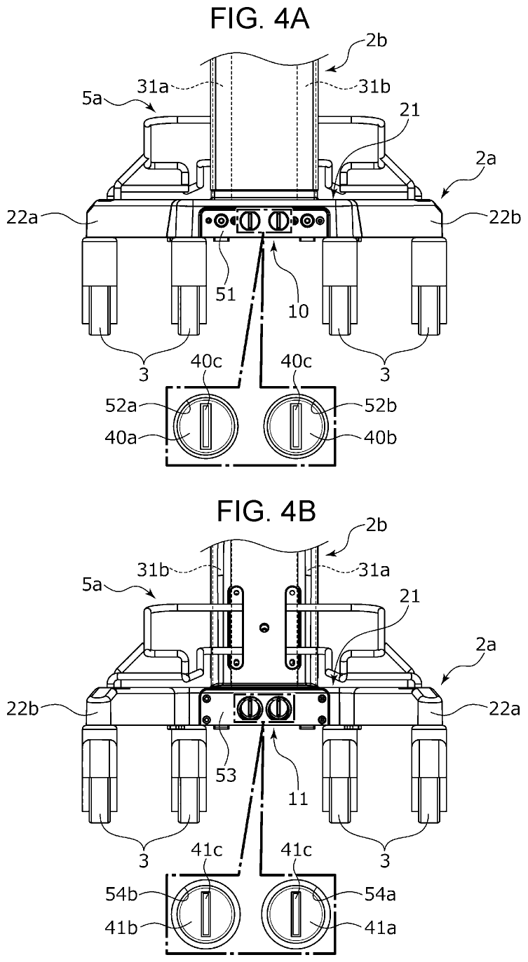

As illustrated in FIGS. 4 and 5, power receiving units 40a and 40b are provided on the front surface side of the base 21, and power transmitting units 41a and 41b are provided on the rear surface side. The power receiving units 40a and 40b are each formed in a substantially cylindrical shape and provided to protrude slightly forward from circular connection openings 52a and 52b formed in a recess 51a on a front wall 51 of the base 21.

Further, as illustrated in FIG. 4A, a concave connection terminal 40c having a vertically long rectangular shape in a front view is provided on each of front surfaces of the power receiving units 40a and 40b. In this way, the power receiving portion 10 includes the power receiving units 40a and 40b each having the connection terminal 40c on the front surface.

Meanwhile, as illustrated in FIG. 4B, the power transmitting units 41a and 41b are each formed in a substantially cylindrical shape, and provided to protrude slightly rearward from circular connection openings 54a and 54b formed on a rear wall 53 of the base 21. In addition, the front wall 51 and the rear wall 53 of the base 21 include the cover member 25.

A convex connection terminal 41c having a vertically long rectangular shape in a front view is provided on the rear surface of each of the power transmitting units 41a and 41b. In this way, the power transmitting portion 11 includes the power transmitting units 41a and 41b each having the connection terminal 41c on the rear surface.

In addition, the power transmitting units 41a and 41b are provided directly behind the power receiving units 40a and 40b. Specifically, the power receiving units 40a and 40b and the power transmitting units 41a and 41b are substantially at the same height from the floor surface, and are arranged approximately at central positions of the cart body 2 in the right-left direction. Further, a right-left separation distance between the power transmitting units 41a and 41b is substantially the same as a right-left separation distance between the power receiving units 40a and 40b.

The front wall 51 includes a cushioning material made of a soft synthetic resin material or a hard rubber material, so that impact caused by contact with another cart 1 is cushioned. Note that, in the present embodiment, the front wall 51 is made of the cushioning material. However, it is sufficient that at least one of the front wall 51 and the rear wall 53 is made of the cushioning material.

In addition, the electronic device 6 is electrically connected to the battery 7 and supplied with power from the battery 7. In addition, the connection terminal 40c of each of the power receiving units 40a and 40b included in the power receiving portion 10, the connection terminal 41c of each of the power transmitting units 41a and 41b included in the power transmitting portion 11, and the battery 7 are electrically connected by an electric circuit (not illustrated), and power supplied to the power receiving portion 10 can be supplied to the battery 7 and the power transmitting portion 11. Then, for example, depending on the situation such as the remaining amount of the battery 7, the battery 7 can be charged with power supplied to the power receiving portion 10, or power can be supplied (transmitted) to the power receiving portion 10 of another cart 1 via the power transmitting portion 11.

Although not particularly illustrated in detail, a wire that electrically connects the battery 7, the electronic device 6, the power receiving portion 10, and the power transmitting portion 11 is stored along the frame members 31a and 31b in a space covered by the cover member 32. Note that a wire insertion hole 55 (see FIG. 5) is formed in an upper wall separating the base 21 and the first frame 33a from each other, and wiring from the power receiving portion 10 and the power transmitting portion 11 to the first frame 33a can be performed.

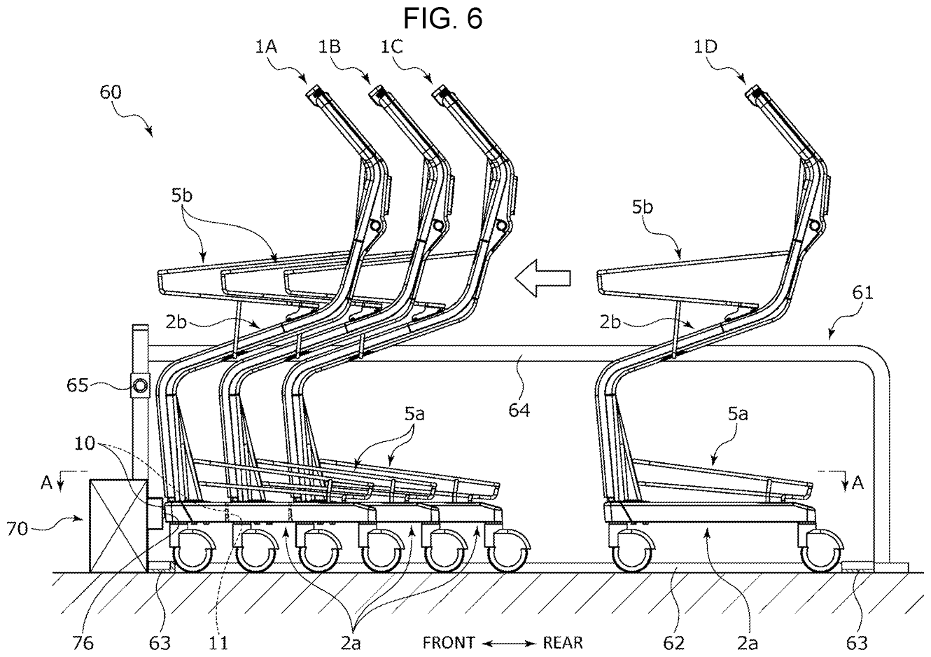

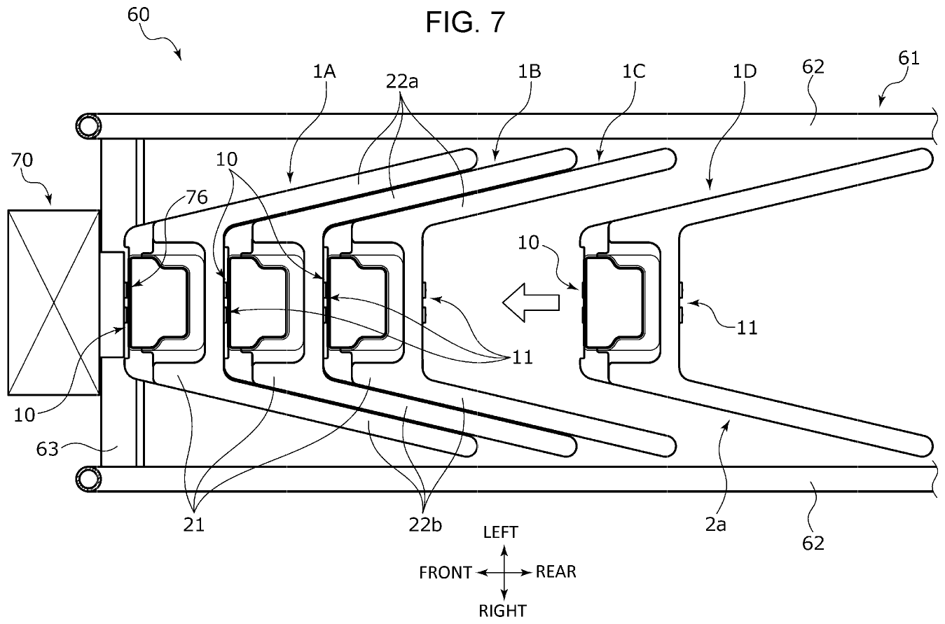

As illustrated in FIGS. 6 and 7, for example, a plurality of carts 1 configured in this way can be stored in a cart storage area 60 installed at a predetermined position in the store. Note that directions indicated by arrows of FIGS. 6 and 7 are described as front, rear, right, and left sides of the cart storage area.

As illustrated in FIGS. 6 and 7, the cart storage area 60 includes a cart gate 61 that guides and stores the cart 1 in the front-rear direction, and an external power supply device 70 that can supply (or transmit) power to the plurality of carts 1 stored in the cart gate 61.

The cart gate 61 is configured in a roughly U-shape in a plan view to surround the front side, the left side, and the right side of the cart storage area 60 except for the rear side by right and left fixed plates 62 and 62 fixed to both right and left sides of the floor surface of the cart storage area 60 and extending in the front-rear direction, coupling plates 63 and 63 directed in the right-left direction to couple the right and left fixed plates 62 and 62 to each other at front and rear positions of the cart gate 61, right and left horizontal pipes 64 extending back and forth and supported by the right and left fixed plates 62 and 62, and a front pipe 65 coupling the right and left horizontal pipes 64, and can guide and store the cart 1 entering from the rear side in a straight line toward the front side.

As illustrated in FIG. 5, the external power supply device 70 is provided with power transmitting units 71a and 71b on the rear surface side. The power transmitting units 71a and 71b have substantially the same configuration as that of the power transmitting units 41a and 41b described above, and the power transmitting units 71a and 71b are each formed in a substantially cylindrical shape, and provided to protrude slightly rearward from a circular connection opening (not illustrated) formed in a rear wall 73.

A vertically long rectangular connection terminal 71c is provided on a rear surface of each of the power transmitting units 71a and 71b. In this way, the power transmitting units 71a and 71b each having the connection terminal 71c are included in a power transmitting portion 76 for external power supply. In addition, height positions of the power transmitting units 71a and 71b from the floor surface are substantially the same as height positions of the power receiving units 40a and 40b and the power transmitting units 41a and 41b from the floor surface.

Next, an operation example of each part when the cart 1 is stored in the cart storage area 60 will be described with reference to FIGS. 6 to 8. Note that, in the following description, for convenience of description, the order in which the carts are stored in the cart storage area 60 will be described using alphabetical reference numerals such as carts 1A, 1B, 1C, and 1D.

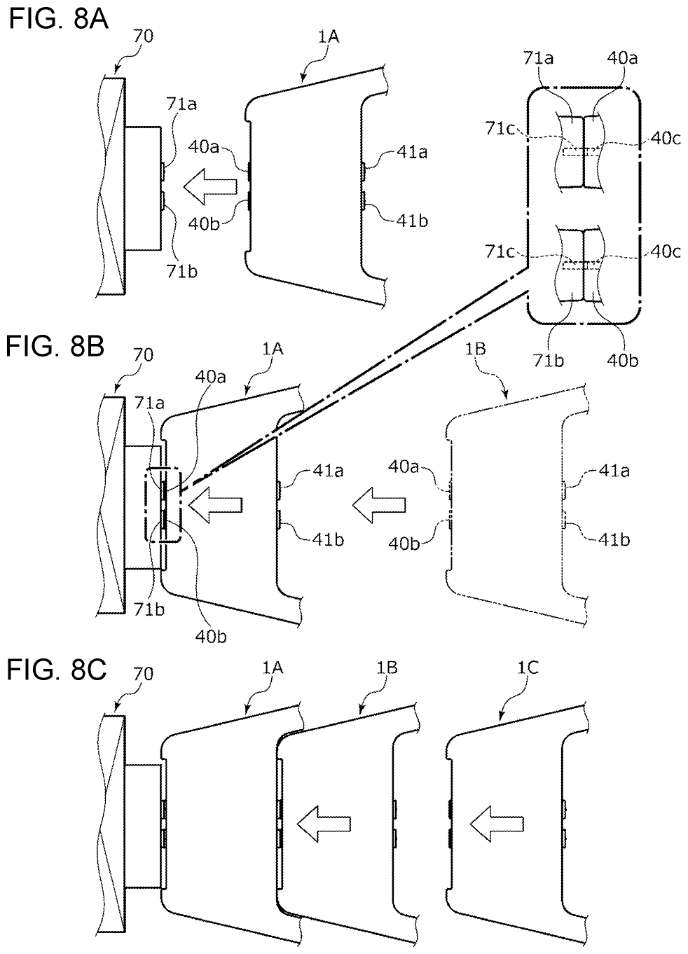

As illustrated in FIGS. 6 and 7, when the foremost cart 1A stored first in the cart storage area 60 is positioned at a foremost storage position in the cart storage area 60, the front surfaces of the power receiving units 40a and 40b of the cart 1A contact the rear surfaces of the power transmitting units 71a and 71b in the external power supply device 70, so that the connection terminal 71c of each of the power transmitting units 71a and 71b of the external power supply device 70 is inserted into the connection terminal 40c of each of the power receiving units 40a and 40b of the cart 1A, and the connection terminal 71c is electrically connected to the connection terminal 40c by contacting the connection terminal 40c (see FIGS. 8A and 8B).

In this way, when the connection terminals 40c and 71c are in a connected state, power can be supplied from the power transmitting units 71a and 71b to the power receiving units 40a and 40b. In addition, power received by the power receiving units 40a and 40b is supplied to the battery 7 via an electric circuit (not illustrated). Therefore, when the cart 1A is stored at the foremost storage position in the cart storage area 60, the connection terminals 40c and 71c of the power transmitting units 71a and 71b and the power receiving units 40a and 40b are in a connected state, and the battery 7 of the cart 1A is charged with power supplied from the external power supply device 70. In addition, power supplied from the external power supply device 70 can be supplied not only to the battery 7 of the cart 1A but also to the power transmitting units 41a and 41b.

As illustrated in FIGS. 6 and 7, the plurality of carts 1A, 1B, 1C, 1D, . . . is configured to be allowed to be nested, that is, stacked in a row in the front-rear direction. For example, when another cart 1B is stacked and stored on the rear side of one cart 1A, a front portion of the lower body part 2a of the cart 1B on the rear side is fit to a space, which has a substantially concave shape in a plan view and whose rear side is open, formed by the base 21 and the right and left side frames 22a and 22b in the lower body part 2a of the cart 1A on the front side, and the upper body part 2b of the cart 1B on the rear side approaches the rear side of the upper body part 2b of the cart 1A on the front side, so that the cart 1B is stored in a row to stack the cart 1A in the front-rear direction.

In addition, when outer surfaces of the base 21 and the side frames 22a and 22b in the lower body part 2a of the cart 1B on the rear side contact inner surfaces of the base 21 and the side frames 22a and 22b of the cart 1A on the front side, movement of the cart 1B on the rear side in forward and right-left directions is restricted, another cart 1 is stored on a rear side of one cart 1 in a row.

Note that, the present embodiment illustrates a mode in which the outer surfaces of the base 21 and the side frames 22a and 22b in the lower body part 2a of the cart 1B on the rear side contact the inner surfaces of the base 21 and the side frames 22a and 22b of the cart 1A on the front side, so that movement of the cart 1B on the rear side in the forward and right-left directions is restricted. However, the invention is not limited thereto, and movement of the cart 1B on the rear side in the forward and right-left directions may be restricted by the outer surface of one of the base 21 and the side frames 22a and 22b of the cart 1B on the rear side contacting the inner surface of one of the base 21 and the side frames 22a and 22b of the cart 1A on the front side. In addition, at least forward movement of the cart 1B on the rear side may be restricted by the upper body parts 2b contacting each other.

As illustrated in FIGS. 6 and 7, when the following cart 1B is guided forward by the cart gate 61 and positioned at a storage position on the rear side of the foremost cart 1A while the cart 1A is stored at the foremost storage position of the cart storage area 60, by the front surfaces of the power receiving units 40a and 40b of the cart 1B contacting the rear surfaces of the power transmitting units 41a and 41b in the cart 1A, the connection terminal 41c of each of the power transmitting units 41a and 41b of the foremost cart 1A is inserted into the connection terminal 40c of each of the power receiving units 40a and 40b of the following cart 1B and electrically connected thereto by contacting the connection terminal 40c (see FIG. 8C).

In this way, when the connection terminals 40c and 41c of the cart 1A supplied with power from the external power supply device 70 and the following cart 1 are in a connected state, power can be supplied from the power transmitting units 41a and 41b of the cart 1A to the power receiving units 40a and 40b of the cart 1B. In addition, power received by the power receiving units 40a and 40b of the cart 1B is supplied to the battery 7 via an electric circuit (not illustrated). Therefore, by storing the following cart 1B so as to be stacked on the rear side of the cart 1A stored in the cart storage area 60, the connection terminals 40c and 41c of the power transmitting units 41a and 41b of the cart 1A and the power receiving units 40a and 40b of the cart 1B are in a connected state, and the battery 7 of the following cart 1B is charged with power supplied from the external power supply device 70 via the power transmitting units 41a and 41b of the cart 1A.

Furthermore, when power supplied from the external power supply device 70 via the power transmitting units 41a and 41b of the cart 1A is supplied to the power transmitting units 41a and 41b of the cart 1B, power is supplied from the power transmitting units 41a and 41b of the cart 1B to the power receiving units 40a and 40b of each of the following carts 1C and 1D, and thus power is supplied to the battery 7 and the power transmitting units 41a and 41b of each of the carts 1C and 1D.

In this way, when the plurality of carts 1A, 1B, 1C, 1D, . . . is stored in the cart storage area 60, the foremost cart 1A is electrically connected to the external power supply device 70, and thus power is supplied to the cart 1A. Further, when the following carts 1B, 1C, 1D, . . . are sequentially stacked and stored on the foremost cart 1A, adjacent front and rear carts 1A and 1B, carts 1B and 1C, carts 1C and 1D . . . are electrically connected to each other, and power supplied from the external power supply device 70 is supplied to the cart 1 on the rear side via the cart 1 on the front side.

As described above, in the cart 1 according to the embodiment, the cart body 2, which can be nested in the front-rear direction, is equipped with the battery 7 that supplies power to the electronic device 6 used for commodity payment processing, the power receiving units 40a and 40b electrically connectable to the power transmitting units 71a and 71b of the external power supply device 70 are provided on the front surface side, and the power transmitting units 41a and 41b for supplying power to the power receiving units 40a and 40b of the following cart 1 nested in this cart 1 are provided on the rear surface side of the power receiving units 40a and 40b. In this way, by sequentially storing the following carts 1B, 1C, 1D, . . . on the foremost cart 1A electrically connected to the external power supply device 70 of the cart storage area 60, the battery 7 mounted on each of the plurality of carts 1A, 1B, 1C, 1D, . . . can be charged using one power supply, and thus a power supply for each cart 1 becomes unnecessary, and equipment of the cart storage area 60 can be simplified.

In addition, the power receiving units 40a and 40b and the power transmitting units 41a and 41b are each provided in front of the placing portion 5a of the lower body part 2a, and thus can be prevented from being damaged by contact with a foot of the user, etc. operating on the rear side of the cart 1. In addition, in the lower body part 2a, by being provided on the front and rear surfaces of the strong base 21 that supports the frame members 31a and 31b included in the upper body part 2b, it is possible to prevent damage by contact with another customer or another cart 1.

In addition, when the side frames 22a and 22b serving as cart guide frames extending rearward are provided on the right and left sides of the power transmitting units 41a and 41b in the cart body 2, the power receiving units 40a and 40b of the cart 1 on the rear side are guided to the power transmitting units 41a and 41b on the front side by the right and left side frames 22a and 22b of the cart 1 on the front side, and thus the connection terminals 40c and 41c are easily connected to each other.

In addition, when the bases 21 of the front and rear carts 1 contact each other, relative positions of the front and rear carts 1 in the front-rear direction are determined. Further, when the right and left side frames 22a and 22b determine relative positions of the front and rear carts 1 in the right-left direction, mutually relative movement becomes difficult. Therefore, connection between the connection terminals 40c and 41c of the power receiving units 40a and 40b and the power transmitting units 41a and 41b is less likely to be released.

In addition, the front wall 51 formed around the power receiving units 40a and 40b includes the cover member 25. That is, by providing the cover member 25 as a cushioning material around the power receiving units 40a and 40b, impact at the time of electrical connection between the connection terminals 40c and 41c of the power receiving units 40a and 40b and the power transmitting units 41a and 41b is relieved by the cover member 25, and thus the connection terminals 40c and 41c are prevented from being damaged.

In addition, when the upper body part 2b of the cart body 2 includes the two frame members 31a and 31b and the cover member 32 covering the outside portions of the two frame members 31a and 31b, and the battery 7 is provided between the two frame members 31a and 31b, there is no need to provide a separate storage place for holding the battery 7. Therefore, resource saving can be achieved, and an extra protruding part is not formed, so that an appearance is excellent, and personal safety is ensured.

In addition, the opening/closing portion 32a of the cover member 32 is removably attached to the frame members 31a and 31b, so that maintenance such as replacement of the battery 7 can be easily performed.

Even though the embodiments have been described above with reference to the drawings, the specific configuration is not limited to these embodiments, and any additions or modifications not depart from the scope of the invention are included in the invention.

For example, in the above embodiment, the description has been given on the premise that the cart is a cart 1 that can be nested in the front-rear direction and has the electronic device 6 used for commodity payment processing. However, the cart 1 does not necessarily have to include the electronic device 6, and may be, for example, a cart capable of detachably including the electronic device 6. In this case, the cart 1 preferably has a mounting member that can detachably provide the electronic device 6, a mobile terminal such as a smartphone, a tablet terminal, etc. to the cart body 2, a connection terminal, etc. for electrically connecting these terminals to the battery 7, etc. Further, in the cart body 2 of the cart 1, the battery 7 for supplying power to the electronic device 6 may be provided, the power receiving units 40a and 40b electrically connectable to the power transmitting units 71a and 71b of the external power supply device 70 may be provided on the front surface side, and the power transmitting units 41a and 41b that supply power to the power receiving units 40a and 40b of the following cart 1 nested in this cart 1 may be provided on the rear surface side of the power receiving units 40a and 40b.

Further, the above embodiment illustrates a mode in which the cart body 2 of the cart 1 includes the lower body part 2a having a substantially bifurcated shape in a plan view and the plate-shaped upper body part 2b erected upward from the front portion of the lower body part 2a. However, the invention is not limited thereto, and the shape of the cart body 2 is not limited to the one described above, and various shapes may be adopted.

Further, the above embodiment illustrates a mode in which the power receiving units 40a and 40b as power receiving portions and the power transmitting units 41a and 41b as power transmitting portions are provided at a front portion of the lower body part 2a of the cart body 2. However, the invention is not limited thereto, and the power receiving units 40a and 40b and the power transmitting units 41a and 41b may be provided at other locations of the lower body part 2a, in the upper body part 2b, etc.

Note that the power receiving portion may be provided not only on the front wall 51 but also, for example, on each of outer surfaces of the side frames 22a and 22b, etc. to be directed obliquely forward. In addition, the power transmitting portion may be provided not only on the rear wall 53 but also, for example, on each of inner surfaces of the side frames 22a and 22b, etc. to be directed obliqued rearward.

Further, the above embodiment illustrates a mode in which, among the power receiving units 40a and 40b as the power receiving portion 10 and the power transmitting units 41a and 41b as the power transmitting portion 11, the power transmitting units 41a and 41b are provided to be movable in the front-rear direction. However, the invention is not limited thereto. The power receiving units 40a and 40b may be provided to be movable in the front-rear direction, and both the power receiving units 40a and 40b and the power transmitting units 41a and 41b may be provided to be movable in the front-rear direction. Alternatively, neither the power receiving units 40a and 40b nor the power transmitting units 41a and 41b may be provided to be movable in the front-rear direction.

Further, the above embodiment illustrates a mode in which the power receiving portion 10 includes the power receiving units 40a and 40b each having the connection terminal 40c on the front surface, and the power transmitting portion 11 including the power transmitting portion 76 for external power supply includes the power transmitting units 41a and 41b each having the connection terminal 41c on the rear surface. However, the invention is not limited thereto. The power receiving portion 10 and the power transmitting portion 11 may include only the connection terminals 40c and 41c. In addition, each of the power receiving units 40a and 40b and each of the power transmitting units 41a and 41b may have the connection terminals 40c and 41c, which may be configured as a female connector and a male connector that can be fit to each other.

Further, the above embodiment illustrates a mode in which when the connection terminals 40c, 41c, and 71c contact one another, power is supplied from the power transmitting portion 76 for external power supply and the power transmitting portion 11 to the power receiving portion 10. However, the invention is not limited thereto. Power may be supplied from the power transmitting portion to the power receiving portion without contact.

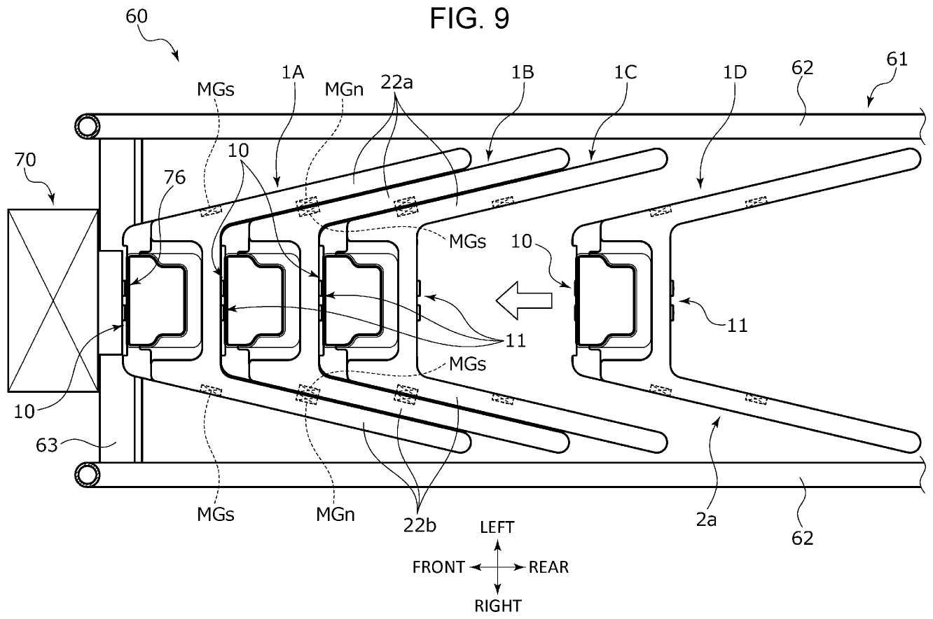

Further, the above embodiment has described a mode having no means for determining a relative position between carts. However, for example, as in a modified example illustrated in FIG. 9, magnets MGs may be provided at predetermined positions on the outer surfaces of the side frames 22a and 22b, and magnets MGn may be provided at predetermined positions on the inner surfaces of the side frames 22a and 22b, so that the magnets MGn of the cart 1A may approach the magnets MGs of the cart 1B when the front and rear carts (for example, the cart 1A, 1B, etc.) are stored to be stacked in a row. In this way, it is possible to prevent electrical disconnection between the connection terminals 40c and 41c of the power receiving units 40a and 40b and the power transmitting units 41a and 41b.

What is claimed is:

1. A shopping cart allowed to be nested in a front-rear direction, comprising:
a cart body;
a battery configured to supply power to an electronic device attached to the cart body and displayed commodity information read by a reading device;
a power receiving portion provided on a front side of the cart body and configured to be electrically connectable to an external power supply; and
a power transmitting portion provided on a rear surface side of the power receiving portion and configured to supply power to a power receiving portion of another shopping cart nested in the shopping cart.

2. The shopping cart according to claim 1, further comprising cart guide frames provided on right and left sides of the power transmitting portion in the cart body and extending rearward.

3. The shopping cart according to claim 1, further comprising a cushioning material provided around at least one of the power receiving portion and the power transmitting portion in the cart body.

4. The shopping cart according to claim 1,
wherein the cart body includes two support frames and a cover covering outside portions of the support frames, and the battery is provided between the support frames.

5. The shopping cart according to claim 2,
wherein the cart body includes two support frames and a cover covering outside portions of the support frames, and the battery is provided between the support frames.

6. The shopping cart according to claim 3,
wherein the cart body includes two support frames and a cover covering outside portions of the support frames, and the battery is provided between the support frames.

7. The shopping cart according to claim 4,
wherein at least a portion of the cover is removably attached to the support frames.

8. The shopping cart according to claim 5,
wherein at least a portion of the cover is removably attached to the support frames.

9. The shopping cart according to claim 6,
wherein at least a portion of the cover is removably attached to the support frames.
